(19) United States
(12) Patent Application Publication
(10) Pub. No.: US 2009/0192866 A1
(43) Pub. Date: Jul. 30, 2009

(54) System and method for using key-value pairing to identify uniquely a communication device on a mobile network

(76) Inventors: Venkatesh Karnam, Sunnyvale, CA (US); Edward Kessler, Los Gatos, CA (US)

Correspondence Address: CARR & FERRELL LLP, 2200 GENG ROAD, PALO ALTO, CA, 94303, US

(21) Appl. No.: 12/012,212

(22) Filed: Jan. 30, 2008

(51) Int. Cl. G06Q 30/00; G06F 17/30; G06F 15/173; G06Q 10/00

(52) U.S. Cl. 705/10; 707/3; 709/223; 705/14; 707/E17.014

(57) ABSTRACT

The present invention provides a system and method for using key-value pairing to identify uniquely a communication device on a mobile network. In some embodiments a user of the device visits the mobile network site of a publisher. The publisher sends header information received from the device to an inventoried content delivery service (ICDS). The ICDS analyzes the header information associated with the device and forwarded by the publisher. The ICDS locates a key-value pair in the header data that can be uniquely associated with the device, and stores the exact value of the key-value pair in a database. The ICDS then may use that value as an index for accumulating information accompanying the value. Thus, the ICDS learns about the actions taken on the mobile network using the device, and can use this information in a variety of ways.

### BACKGROUND OF THE INVENTION

1. Field of the Invention

This invention relates to identifying users of mobile networks, and particularly to identifying uniquely a communication device on a mobile network.

2. Description of Related Art

People around the world use portable communication devices that are linked to each other and to servers or other computing devices through mobile networks. A mobile network is a network of communication links among users of mobile devices (such as mobile phones and personal digital assistants) and carriers (such as Verizon, Sprint, etc.), and may also include publishers of content for display on mobile devices, advertisers, and inventoried content delivery services (ICDS) such as entities delivering advertisements (“ads”) from advertisers to publishers for display to users.

Inventoried content is information that becomes part of the content of a display sent by a publisher to a user of a mobile communication device on a mobile network, and that is subject to some kind of accounting. Ads are one type of inventoried content that may be shown on a user's mobile phone or personal digital assistant, as part of a display presented by a publisher to the user. Among other activities, an ICDS develops an inventory of ads from advertisers, and delivers those ads for display to users.

There are several reasons why an ICDS may want to be able to identify users uniquely, or individually. These might include the ICDS's desire to track the pages a user visits on a publisher's site, an advertiser's desires for targeting ads to specific users based on demographics or behavioral data and for frequency capping, and/or for ensuring that a given user is not shown the same ad more than a certain number of times.

For example, an advertiser may have an ad that is to be targeted to a particular subset of all users, such as those in a given geographic area, those receiving content from a given publisher, those accessing their devices during a given time period, or those using a particular make and model of communication device. These subsets may sometimes overlap in various ways.

Also, users' responses to ads, as measured, for instance, by click-through rates, may be negatively affected by excessive ad impressions. Thus, it may be desirable to have a limit on the number of instances of display (“impressions”) of an ad that may be shown to a user during a given time period, beyond which the advertiser will not pay the ICDS for the delivery of additional impressions. These limits may vary for different users.

An ICDS also may wish to collect data in order to build a behavioral profile of individual users, and offer market research to advertisers and publishers. The ICDS also may use such research itself, to study user behavior on publisher sites, to target ads very finely and/or to allocate inventory most effectively to some particular users and not to others, for example.

For at least these reasons, it is helpful to an ICDS to be able to identify uniquely individual mobile devices.

### SUMMARY OF THE INVENTION

The present invention provides a system and method for using key-value pairing to identify uniquely a communication device on a mobile network. In some embodiments a user of such a device (e.g., a mobile phone) visits the mobile network site of a publisher of content for mobile devices. The publisher sends header information received from the device to an inventoried content delivery service (ICDS) such as an advertisement broker. The ICDS analyzes the header information associated with the device and forwarded by the publisher. The ICDS determines at least one key-value pair in the header data that can be uniquely associated with the device. The ICDS stores the value of the key-value pair in a database, and uses the specific value of the key-value pair to identify the device uniquely. Whenever the ICDS recognizes the same specific value in other header information received from any publisher, the ICDS may associate any data accompanying that specific value with that device, and with the data stored in the database, thus accumulating information about the device. Such information may include data about ads displayed on the device or acted upon by a user of the device. These data may be useful to the ICDS in various ways, for example, in optimizing the allocation of its inventory by improving its ability to target ads and to control the frequency of ad displays on particular devices, as well as by improving its general market research.

### BRIEF DESCRIPTION OF THE DRAWINGS

FIG. 1 is a block diagram of an exemplary architecture in which key-value pairing may be used to identify uniquely a mobile communication device according to the present invention.

FIG. 2 is a flow chart of an exemplary method for using key-value pairing to identify uniquely a mobile communication device according to the present invention.

### DETAILED DESCRIPTION OF THE INVENTION

The present invention provides a system and method for uniquely identifying communication devices on a mobile network using key-value pairing. Embodiments of the present invention make it possible for an ICDS to identify a mobile device uniquely, without determining the exact identity of the user or owner of the device.

In some embodiments, an ICDS provides code to a publisher that captures one or more hypertext transfer protocol (“http”) headers sent from a user device, carrier gateway or other intermediary (such as a transcoding service) to the publisher. The publisher then sends the header name (the “key”) and the header value (the “value”) to the ICDS at some point in time, for example, after a given time interval has passed, when a page on the publisher's mobile network site is visited, and/or when an ad is requested.

In an exemplary embodiment, the publisher sends the header information to the ICDS when an ad is requested. The ICDS analyzes the header information forwarded with the ad request by its publisher code to find at least one of the key-value pairs that are known to be uniquely associated with a given device. In other words, if earlier analysis has shown that ABCD-xxxx headers are uniquely associated with particular devices, then the ICDS will search for an ABCD-xxxx key-value pair. Examples of such key-value pairs include (but are not limited to) the MSISDN and its associated value, and a subnode identifier and its value.

When such a key-value pair is found, its exact value in the header accompanying the given ad request is saved as a unique device identifier. That is the key-value pair takes on a unique value associated with each mobile device, so that only one specific device is associated with the key-value pair ABCD-1234. Thus, if the ICDS searches for ABCD-xxxx and finds the value ABCD-1234 accompanying a given ad request, the ICDS may store ABCD-1234 in a database and use it to recognize uniquely the device from which the header originated. Information accompanying other ad requests received by the ICDS that also contain the value ABCD-1234 for the key-value pair ABCD-xxxx may be associated with the unique device identifier ABCD-1234, and may be stored and analyzed as data reflecting the behavior of the user at the device identified by ABCD-1234. The ICDS may optionally encrypt the key-value pair for additional privacy assurance.

The success of this method of using one or more headers to identify a unique user may vary with the kind of device and carrier gateway used. It is believed that embodiments of the invention may yield the unique identification of about seventy percent of mobile network users in the U.S.A., for example. This success rate may increase as additional uniquely identifying key-value pairs are found.

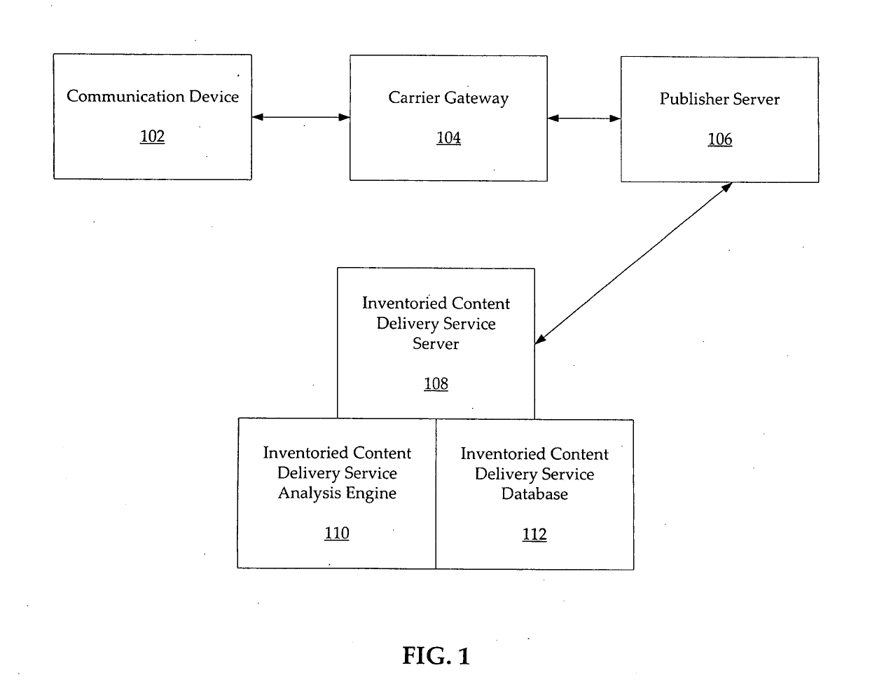

FIG. 1 is a block diagram of an exemplary architecture in which a method of using key-value pairing to identify uniquely a mobile communication device according to the present invention may be used. A communication device 102, such as a mobile phone is connected to a mobile network. Signals from the phone 102 are carried by a gateway 104 of a mobile service carrier. A publisher of content for display to users on mobile networks operates a server 106. An ICDS operates an exemplary system comprising a server 108, an analysis engine 110, and a database 112.

In practice, a user of the communication device 102 visits the site of a publisher on the server 106 via the carrier gateway 104. In the exemplary embodiment discussed above, the publisher's server 106 passes a request for an ad to be provided to the user's phone 102 to an ICDS server 108. The ICDS's publisher code also causes the publisher's server 106 to send all header information received from the user's device by the publisher to the ICDS server 108 along with the ad request.

The ICDS analysis engine 110 analyzes the header information to determine whether any key-value pairs that uniquely identify device 102 are present. If so, the received header name and header value of the key-value pair may be stored in an ICDS database 112. Other information about the analyzed ad request may also be stored in database 112 in association with the specific value of the key-value pair.

Subsequent ad requests are received by the IDS server 108 and similarly analyzed by the engine 110. When the engine 110 finds in another ad request another value that is identical to a value already stored in database 112, the engine 110 may store any additional information from the subsequent ad request in the database 112 and associate it with the already stored value. Thus, information about the ads presented to a user of the uniquely identified device 102 may accumulate in the database 112.

Further, information about how a user of the device 102 interacts with presented ads may also be analyzed by engine 110 (or another computing device) and stored in database 112 (or an associated database). For example, if the user interacts primarily with sports-related ads on Fridays, or travel-related ads in June, or food-related ads at 5 PM, information about these actions may be stored and analyzed. Based on the analyses, the ICDS may determine that certain kinds of ads should be presented to the user at certain times, to increase the effectiveness of the targeting of its advertisement inventory.

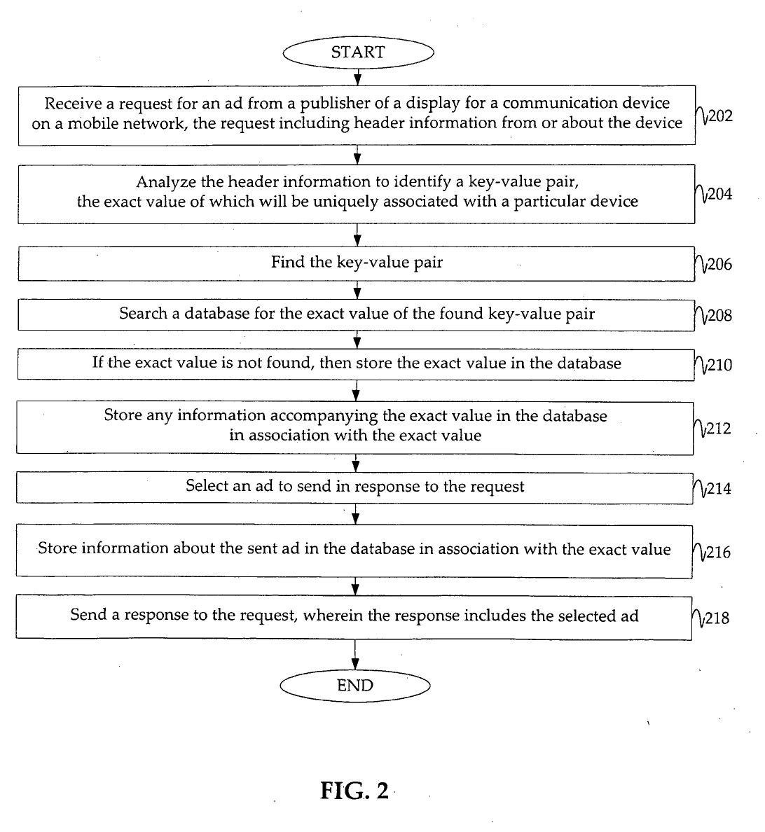

FIG. 2 is a flow chart of an exemplary method for using key-value pairing to identify uniquely a mobile communication device according to the present invention. For illustration, this exemplary method involves the publisher's sending header information to the ICDS when an ad is requested, but again, the publisher may send header information to the ICDS at any time, including (but not limited to) when the user visits a page on the publisher's site.

In this example, when a user of a communication device visits a publisher's site on a mobile network, at step 202 the ICDS receives a request from the publisher's server for an ad to display to the user of the device. As above, the ICDS receives other header information from and about the device from the publisher along with the ad request. At step 204 the ICDS analyzes the header information to find one or more key-value pairs that are uniquely associated with the particular device. At step 206 the ICDS finds such a key-value pair. If desired, the ICDS may encrypt the key-value pair without reducing its usefulness as a unique identifier of the device for which the ad is requested. At step 208 the ICDS attempts to match the received value to values that the ICDS has previously received, to determine whether the device has previously been identified.

If the device has not been previously identified, at step 210 the ICDS stores the value. At step 212 the ICDS also stores any other information that is desired (for example, information about the ad request) and associates it with the value. At step 214 the ICDS selects an ad to send in response to the ad request. The selection may be informed by analyses of the information previously accumulated with respect to the value, and/or of other information in the database. At step 216 the ICDS stores the information about the sent ad in connection with the value. At step 218, the ICDS sends a response to the ad request, including the selected ad.

For example, a user of a mobile phone may visit the mobile network site of a publisher. The publisher sends an ad request to an ICDS, along with header information from and about the mobile phone. The ICDS analyzes the header information, and locates a subnode key-value pair, a type of key-value pair that is uniquely associated with particular mobile devices. The ICDS stores the exact value of the subnode (XYZ-123), along with other information from the headers and/or about the ad that it returns in response to the request. Some time later, the ICDS receives another ad request with header information that contains the subnode header having the value XYZ-123. The ICDS finds XYZ-123 in its database, and stores additional information from the new headers and about the new ad it sends in response to the new request, in the database in association with XYZ-123. The new ad need not be requested by the same publisher as that from which the header value XYZ-123 was first received; that is, the ICDS can recognize the device uniquely associated with XYZ-123 across different sessions, publishers, and dates, for example.

Similarly, if the ICDS receives an action on an ad that is accompanied by header information including XYZ-123, information about the action (such as the kind of ad, the time of day, etc.) can be stored in the database in association with XYZ-123. At any time, the ICDS may analyze the ad display data, accumulated behavioral data, and any other data associated with XYZ-123 in its database. The ICDS may use its analysis to determine which ad from its inventory would be best to send in response to an ad request accompanied by XYZ-123. For example, if the device associated with XYZ-123 has interacted with a fast-food ad at about 5 PM, the next time the ICDS receives a request for an ad associated with XYZ-123 at about 5 PM, it may preferentially provide a fast-food ad, rather than some other ad, such as one randomly chosen from its inventory. If the same fast-food ad has been sent in response to a request associated with XYZ-123 three times already, the ICDS may preferentially provide a different fast-food ad. If devices of the same make and model as that associated with XYZ-123 more often interact with pizza ads than hamburger ads, then the ICDS may preferentially provide a pizza ad.

Embodiments of the present invention enable an ICDS to identify a mobile device uniquely. The identity of a user of the device need not be known, and the information that uniquely identifies the device may be encrypted without decreasing its usefulness as a unique identifier. Embodiments of the present invention can improve the ability of an ICDS to allocate its inventory in an optimized manner, based on any criteria, including, but not limited to, ensuring that a given ad is not shown on a particular device more than a predetermined number of times, or number of times per unit of time (e.g., three times per day); to provide ads for display on the device based on the population of ads previously shown on, or acted on using, the device; and to provide ads for display based on other information associated with the device, such as its make and model, the time of day when it is used, etc. The present invention is also useful as a tool for behavioral or market research, for any purpose.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for using key-value pairing to identify uniquely a communication device on a mobile network, the method comprising:
receiving header information from or about the device from a publisher;
locating in the header information a key-value pair in which the value is uniquely associated with a particular device;
searching a database for the value of the located key-value pair;
storing the value in the database if it is not already stored in the database; and
storing any information accompanying the value in the database with the value.

2. The method of claim 1, wherein the key-value pair comprises an MSISDN header.

3. The method of claim 1, wherein the key-value pair comprises a subnode.

4. The method of claim 1, further comprising an initial step of analyzing all received header data in the database to determine which key-value pairs have a value that is uniquely associated with a particular device.

5. The method of claim 1, further comprising encrypting the value before storing it in the database.

6. The method of claim 1, wherein the header information is received with a request for an ad to be displayed on the device.

7. The method of claim 6, further comprising:
selecting an ad to send in response to the request;
storing information about the sent ad in the database with the value; and
sending a response to the request including the selected ad.

8. The method of claim 7, wherein selecting an ad further comprises analyzing data in the database associated with the value to determine which ad to send in response to the request.

9. A system for using key-value pairing to identify uniquely a communication device on a mobile network, comprising:
a server, configured to receive header information from or about the device from the publisher;
an analysis engine, configured to locate in the header information a key-value pair having a value that is uniquely associated with the device; and
a database, configured to store the value and additional data associated with value.

10. The system of claim 9, further comprising a module for sending header information from the publisher to the server.

11. The system of claim 9, further comprising a module for encrypting the value before storing it in the database.

12. The system of claim 9, wherein the analysis engine is further configured to analyze all of the header information in the database to identify additional key-value pairs, the values of which are uniquely associated with particular devices.

13. The system of claim 9, further comprising a second analysis engine for analyzing all of the header information in the database to identify additional key-value pairs, the values of which are uniquely associated with particular devices.

14. The system of claim 9, wherein the server is further configured to receive a request for inventoried content from a publisher for display on the device, and to send inventoried content in response to the request.

15. The system of claim 14, wherein the analysis engine is further configured to select inventoried content to send to the device in response to the request.

16. The system of claim 15, wherein the database is further configured to store inventoried content, and to store information about the inventoried content.

17. The system of claim 16, wherein the inventoried content comprises an advertisement.

18. A computer readable medium having embodied thereon a program, the program being executable by a processor for performing a method for using key-value pairing to identify uniquely a communication device on a mobile network, the method comprising:
receiving header information from or about the device from a publisher;
locating in the header information a key-value pair in which the value is uniquely associated with a particular device;
searching a database for the value of the located key-value pair;
storing the value in the database if it is not already stored in the database; and
storing any information accompanying the value in the database with the value.

19. The computer readable medium of claim 18, wherein the key-value pair comprises an MSISDN header.

20. The computer readable medium of claim 18, wherein the key-value pair comprises a subnode.

21. The computer readable medium of claim 18, wherein the method further comprises an initial step of analyzing all received header data in the database to determine which key-value pairs have a value that is uniquely associated with a particular device.

22. The computer readable medium of claim 18, wherein the method further comprises a step of encrypting the value before storing it in the database.

23. The computer readable medium of claim 18, wherein the header information is received with a request for an ad to be displayed on the device.

24. The computer readable medium of claim 23, wherein the method further comprises:
selecting an ad to send in response to the request;
storing information about the sent ad in the database with the value; and
sending a response to the request including the selected ad.

25. The computer readable medium of claim 24, wherein selecting an ad further comprises analyzing data in the database associated with the value to determine which ad to send in response to the request.
